(19) United States
(12) Patent Application Publication
(10) Pub. No.: US 2004/0056603 A1
(43) Pub. Date: Mar. 25, 2004

(54) Electron gun and cathode-ray tube

(76) Inventor: Norifumi Kikuchi, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/610,583

(22) Filed: Jul. 2, 2003

(30) Foreign Application Priority Data
Jul. 4, 2002 (JP) P2002-196443

(51) Int. Cl. G09G 3/10

(52) U.S. Cl. 315/169.1

(57) ABSTRACT

An electron gun of the present invention is provided with focus electrodes G5A, G5B, an anode electrode G6 disposed on a side subsequent to the focus electrodes, and a prior electrode G4 disposed on a side prior to and next to the focus electrode G5A, G5B, as shown in FIG. 14, for example. To the prior electrode G4 an intermediate potential between an anode potential and a focus potential is supplied through a resistor 35. Therefore, electron beams emitted from cathodes are accelerated at the early stage in the prior electrode G4, and repulsion between the electron beams is restrained, so that the increase in a beam spot diameter on a fluorescent screen is restrained. Further, since a voltage dividing terminal is positioned distant from the high-voltage side, discharge within the cathode-ray tube is restrained. A cathode-ray tube of the present invention includes the above electron gun.

### BACKGROUND OF THE INVENTION

1. Field of the Invention

The present invention relates to an electron gun and a cathode-ray tube provided with the electron gun.

2. Description of the Related Art

Lately, higher resolution has been in great demand in a cathode-ray tube employed in a television receiver, a computer display or the like. To meet the above demand, therefore, in an electron gun applied to the cathode-ray tube, the diameter of an electron beam spot has been required to be small.

FIG. 1 shows a basic construction of a conventional in-line type electron gun. An in-line-type electron gun 1 includes a plurality of electrodes, that is, a first electrode G1, a second electrode G2, a third electrode G3, a fourth electrode G4, a fifth electrode G5, and a sixth electrode G6 sequentially arrayed such that each of the electrodes is common to three in-line arrayed cathodes K [KR, KG, and KB] corresponding to red, green, and blue, respectively. Subsequent to the sixth electrode G6, a shield cup G7 is integrally provided with the sixth electrode G6.

A high-voltage potential (anode voltage) of, for example, approximately 20 kV to 35 kV is supplied to the sixth electrode G6. Static focus voltage FS of, for example, approximately 5 kV to 10 kV is supplied to the fifth electrode G5 and the third electrode G3. A low-voltage of, for example, approximately 400V to 1500V is supplied to the fourth electrode G4 and the second electrode G2. Zero voltage is supplied to the first electrode G1. A main electron lens is formed of the fifth electrode G5 and the sixth electrode G6.

FIG. 2 shows another example of a conventional inline-type electron gun. An in-line type electron gun 4 has the construction in which the fifth electrode G5 shown in FIG. 1 is divided into two electrodes, the fifth A electrode G5A and the fifth B electrode G5B, to form a quadrupole lens compensating astigmatism in a deflection yoke. In this example, to the third electrode G3 and the fifth A electrode G5A a static focus voltage FS of, for example, approximately 5 kV to 10 kV is supplied, and to the fifth B electrode G5B a dynamic focus voltage FV of, for example, approximately 5 kv to 10 kV is supplied. Other than that, the construction is similar to that shown in FIG. 1. Such in-line-type electron gun having a quadrupole lens also has conventionally been known.

Conventionally, to the cathodes K and each of the electrodes from the first electrode G1 to the fifth electrode G5, voltage is supplied from a stem pin 2 in an electron gun supporting portion, and a high-voltage potential is supplied to the sixth electrode G6 through an internal conductive film (such as an internal carbon film).

Further, lately, as shown in FIG. 3, there has also been known an in-line-type electron gun 6 in which a static focus voltage FS is supplied to the third electrode G3 and the fifth A electrode G5A by means of a voltage divided from an incorporated resistor 5 (referring to FIG. 7) that is connected between the sixth electrode G6 and the stem pin 2 of zero voltage. Other than that, the construction is similar to that shown in FIG. 2 (referring to Japanese Laid-open Patent Publication Hei7-94117).

Furthermore, as shown in FIG. 4, there has also been known an in-line-type electron gun 7 in which in order to reduce the aberration of a main electron lens, between the fifth electrodes G5 [G5A, G5B] and the sixth electrode G6 consisting the main electron lens, an intermediate electrode GM having an intermediate potential VG (approximately 15 kV) between a potential (5 kV to 10 kV) of the fifth electrodes G5 [G5A, G5B] and a potential (25 kV to 30 kV) of the sixth electrode G6 is disposed. In this example, the static focus voltage FS is supplied from the stem pin 2 to the third electrode G3 and the fifth A electrode G5A, and the potential VG is supplied to the intermediate GM by means of a voltage divided from an incorporated resistor 5 connected between the sixth electrode G6 and the stem pin 2 of zero voltage. Other than that, the construction is similar to that shown in FIG. 3. Providing the intermediate electrode GM enables a potential in the main electron lens to increase gradually and to reduce the aberration (referring to Japanese Laid-open Patent Publication Hei9-320485).

As described above, in order to obtain a higher resolution in a cathode-ray tube, it is preferable that the diameter of a beam spot on the fluorescent screen is as small as possible; and it is also preferable that from a low current region through a high current region of a cathode current the beam spot diameter remains small. However, in the above-described constructions of the electron gun, the beam spot diameter becomes unavoidably large due to repulsion as the current increases, and the focusing characteristic in a high current region may deteriorate.

FIG. 16 shows a simplified electron lens system (main electron lens LM) in which a beam spot diameter P1 at the crossover point in an electron gun 16 and a beam spot diameter P2 converged on a screen 15 are schematically shown.

In the electron gun 7 shown in FIG. 4, an intermediate potential (medium voltage) VM is supplied to the intermediate electrode GM by means of a voltage divided from the incorporated resistor 5. At that time, a branch terminal (medium voltage terminal) tM is provided in the vicinity of a high-voltage terminal tH (on the anode side) of the incorporated resistor 5. A terminal tE represents an earth terminal. As shown in FIGS. 5 and 6, the incorporated resistor 5 is disposed on the outside of a bead glass 9A that is one of a pair of bead glasses 9 (9A, 9B) supporting each electrode in the electron gun 7, such that the incorporated resistor 5 comes close to the inside surface of a neck portion 10N of a cathode-ray tube assembly 10 (made of glass). As described above, when the incorporated resistor 5 is disposed close to the inside surface of the cathode-ray tube, an inside surface portion 13 of the neck adjacent to the sixth electrode G6 is affected and electrically charged by a high-voltage potential of the sixth electrode G6 (for example about 30 kV). As a result, from the branch terminal tM (having, for example, a half of the anode potential, that is, about 15 kV) of the incorporated resistor 5, electrons tend to emit toward the charged inside surface portion 13 of the neck, which may cause discharge.

In light of the above, the present invention is to provide an electron gun and a cathode-ray tube in which the beam spot diameter is small in the range of a low current region to a high current region, thereby improving the focusing characteristic and the voltage withstanding characteristic.

### SUMMARY OF THE INVENTION

An electron gun according to the present invention includes a focus electrode, an anode electrode disposed on a side subsequent to the focus electrode, and a prior electrode disposed on a side prior to and next to the focus electrode, in which an intermediate potential between an anode potential and a focus potential is supplied to the prior electrode by means of a voltage divided through a resistor.

According to the electron gun of the present invention, since the intermediate potential between the anode voltage and the focus voltage is supplied to the electrode prior to the focus electrode, electron beams emitted from a cathode are accelerated at the early stage in the prior electrode to prevent repulsion between the electron beams, whereby on the fluorescent screen the increase in diameter of the beam spot is restrained. Accordingly, the focusing characteristic can be improved in the range of a low current region to a high current region of the cathode current. Further, since a voltage dividing terminal in a resistor that supplies the intermediate potential is disposed distant from the high-voltage side, in other words, the voltage dividing terminal is disposed distant from the high-voltage charged surface portion of the cathode-ray tube, discharge can be efficiently restrained.

A cathode-ray tube according to the present invention includes an electron gun having a focus electrode, an anode electrode disposed on a side subsequent to the focus electrode, and a prior electrode disposed on a side prior to and next to the focus electrode, in which an intermediate potential between an anode potential and a focus potential is supplied to the prior electrode by means of a voltage divided through a resistor.

According to the cathode-ray tube of the present invention, since the above-described electron gun is included, the focusing characteristic in the range of a low current region to a high current region of the cathode current is improved, and also the voltage withstanding characteristic is improved to obtain a picture in high intensity, high resolution, and high reliability.

### BRIEF DESCRIPTION OF THE DRAWINGS

FIG. 1 is a constitutional diagram showing an example of a conventional electron gun;

FIG. 2 is a constitutional diagram showing another example of a conventional electron gun;

FIG. 3 is a constitutional diagram showing a further example of a conventional electron gun;

FIG. 4 is a constitutional diagram showing a still further example of a conventional electron gun;

FIG. 5 is a cross-sectional view of a neck portion of a cathode-ray tube in which an electron gun is sealed;

FIG. 6 is a longitudinal sectional view of the neck portion of a conventional cathode-ray tube in which an electron gun is sealed;

FIG. 7 is a constitutional diagram of an example of a conventional incorporated resistor;

FIG. 8 is a constitutional diagram showing an embodiment of a cathode-ray tube according to the present invention;

FIG. 9 is a constitutional diagram showing an embodiment of an electron gun according to the present invention;

FIG. 10 is a constitutional diagram showing another embodiment of an electron gun according to the present invention;

FIG. 11 is a constitutional diagram showing an incorporated resistor according to the present invention;

FIG. 12 is an explanatory view for explaining a voltage withstanding characteristic of an electron gun according to the present invention;

FIG. 13 is another embodiment of an electron gun according to the present invention;

FIG. 14 is further embodiment of an electron gun according to the present invention;

FIG. 15 is a characteristic curve showing the relationship between a beam spot diameter on a screen and the cathode current, comparing an electron gun of the present invention and that of a conventional example; and

FIG. 16 is a schematic view showing an aperture of an electron lens with a beam spot diameter at the crossover point in an electron gun and that on a screen.

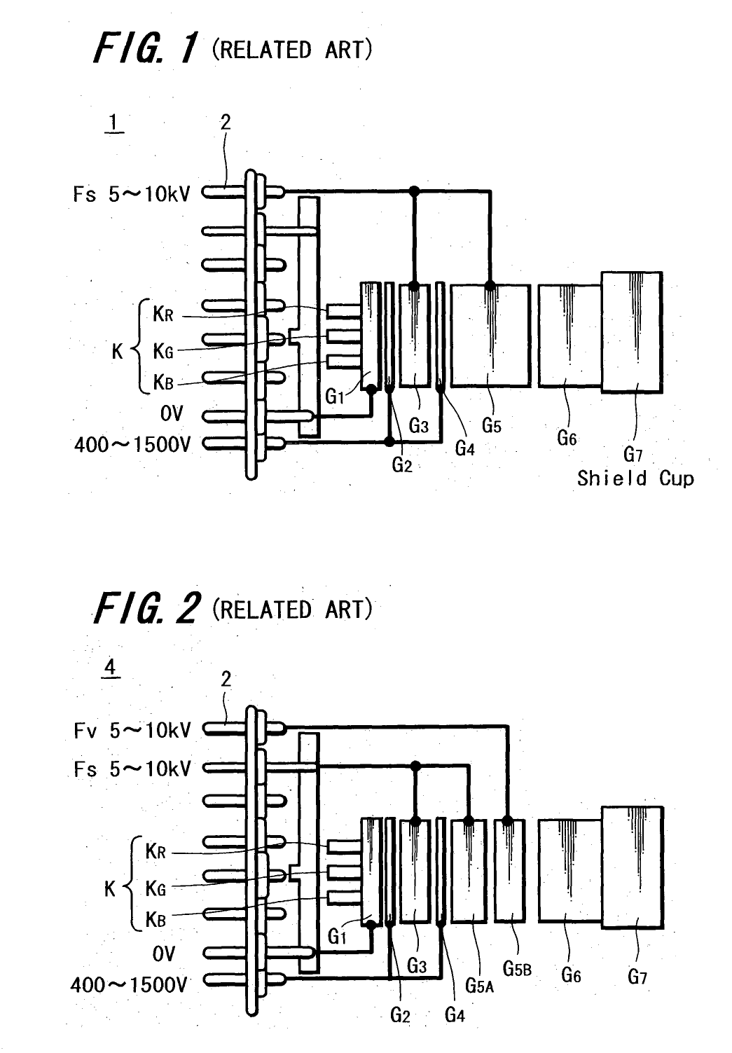

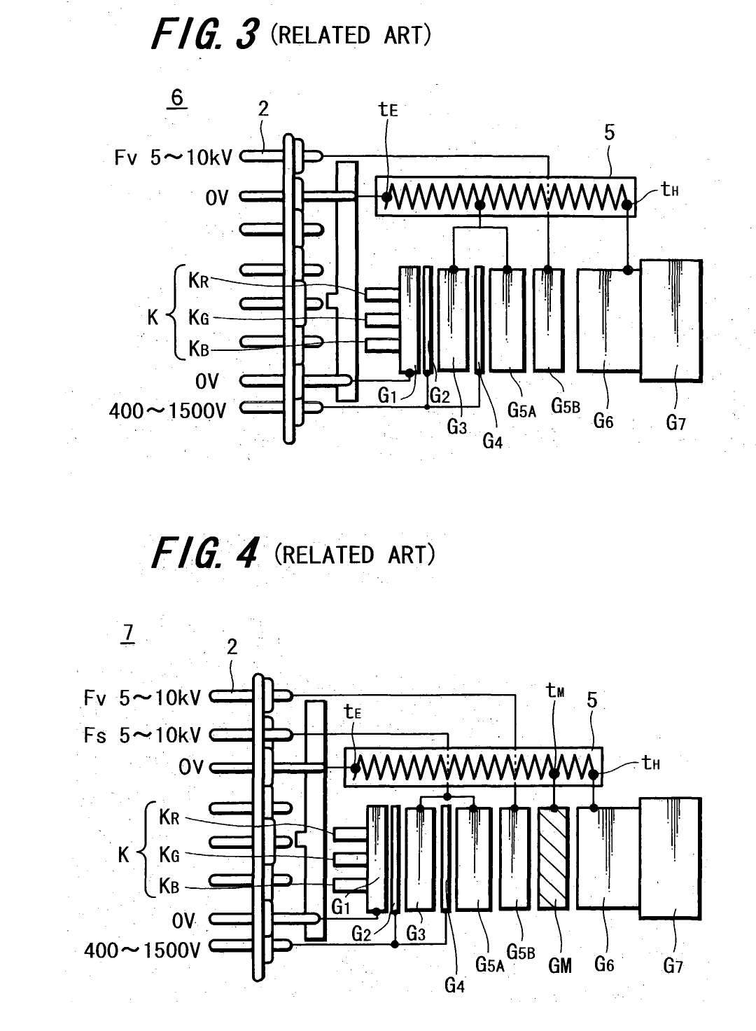

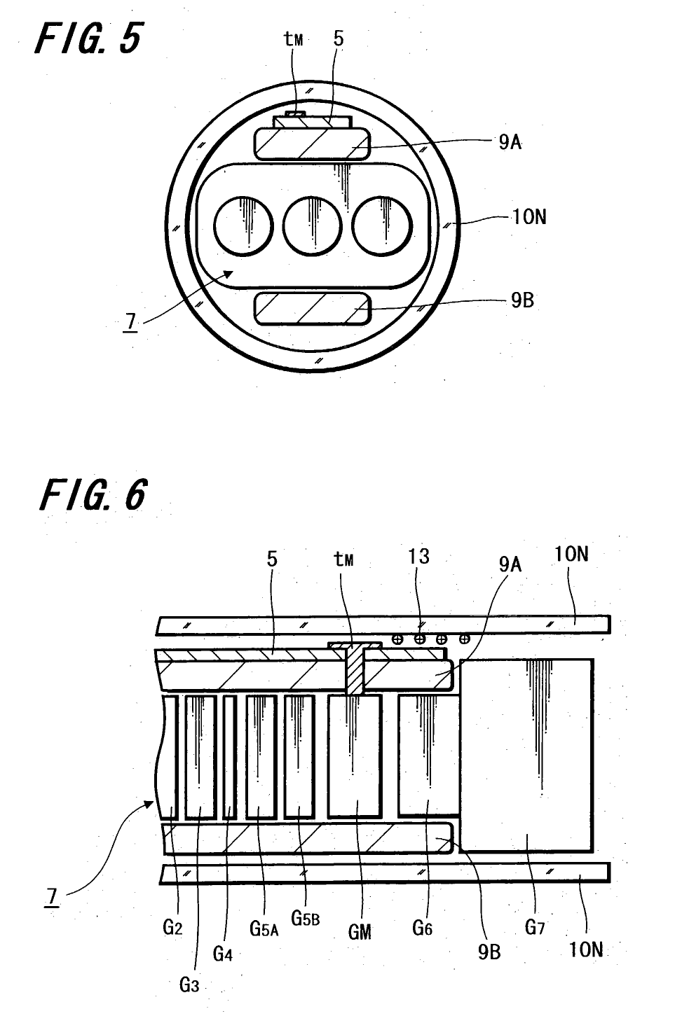

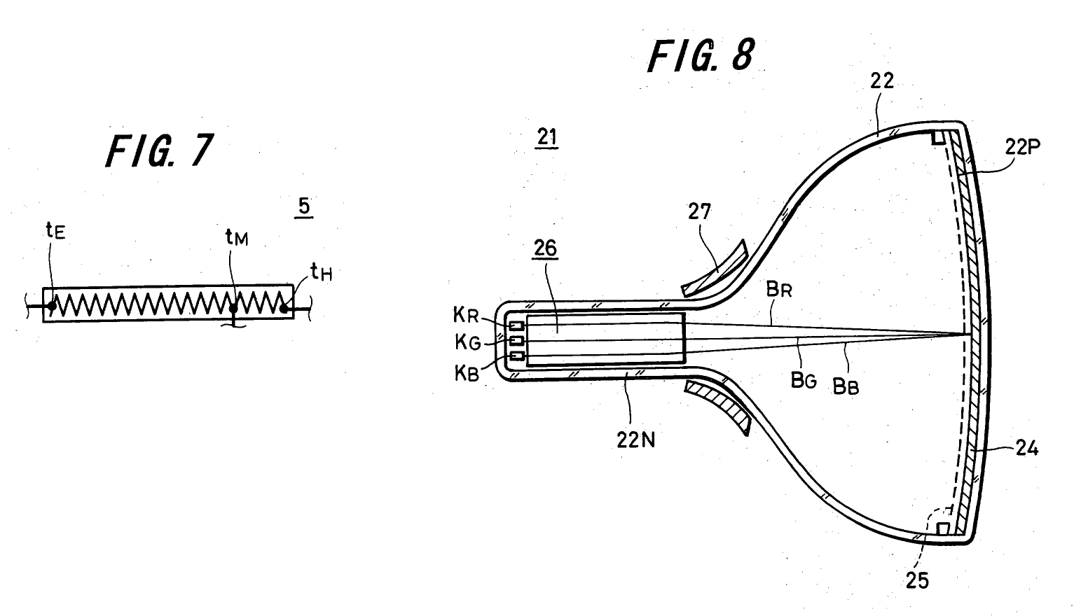

### DESCRIPTION OF THE PREFERRED EMBODIMENT

Hereinafter, embodiments of the present invention will be described referring to the drawings.

FIG. 8 shows an embodiment of a color cathode-ray tube according to the present invention. A color cathode-ray tube 21 of the present invention includes a color fluorescent screen 24 composed of each color fluorescent layer of red (R), green (G), and blue (B) provided on the inside surface of a panel 22P of a cathode-ray tube assembly 22 (for example, made of glass). A color selection mechanism 25 is provided opposing to the fluorescent screen 24, and an in-line-type electron gun 26 (described later on) is provided within a neck portion 22N. On the outside of the cathode-ray tube assembly 22, there is provided a deflection yoke 27 that deflects each of the electron beams BR, BG, and BB emitted from the electron gun 26 in horizontal and vertical directions.

In the color cathode-ray tube 22, each of the electron beams B [BR, BG, and BB] that is respectively emitted from the cathodes K [KR, KG, and KB] corresponding to the colors of the electron gun 26 is converged on a main electron lens formed of a plurality of electrodes to be focused and converged on the fluorescent screen 24 and then impinged upon each of the fluorescent layers red, green, and blue. The electron beams BR, BG, and BB are deflected by the deflection yoke 27 in horizontal and vertical directions, thereby displaying the required color picture.

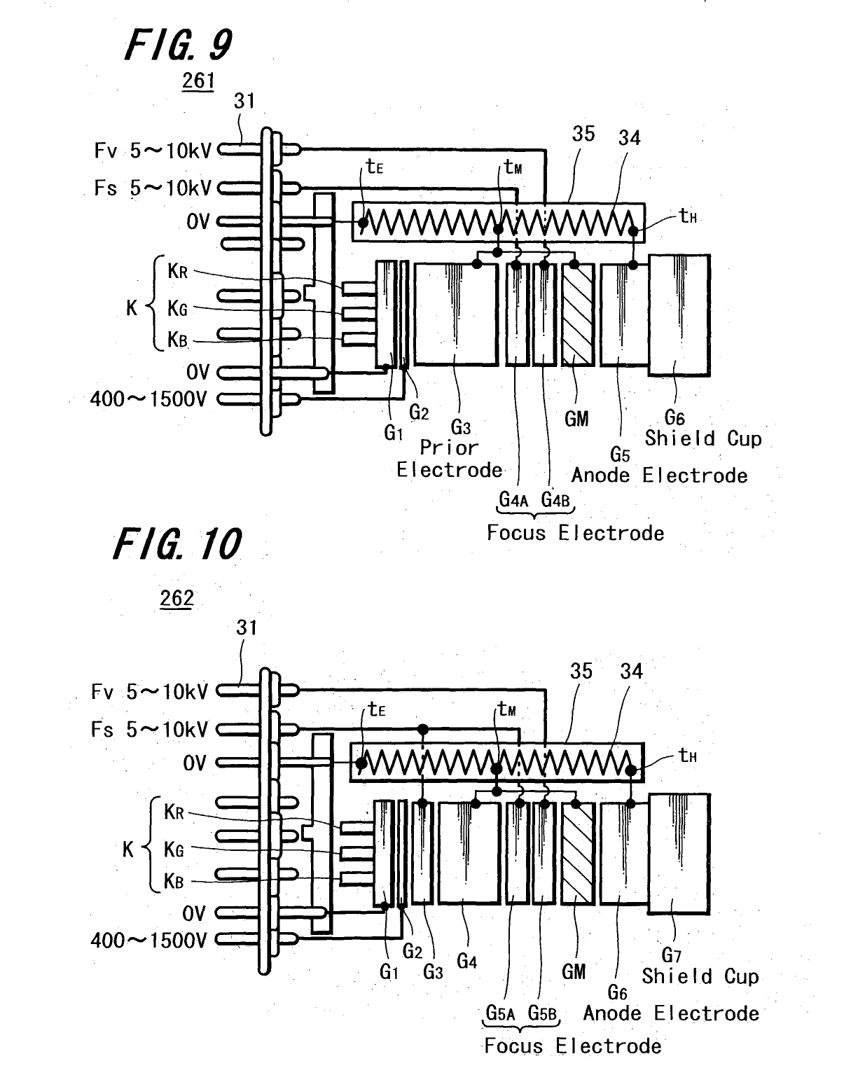

FIG. 9 shows an embodiment of the electron gun 26 in the above-mentioned cathode-ray tube 21. An in-line-type electron gun 261 according to the embodiment includes a plurality of electrodes: a first electrode G1, a second electrode G2, a third electrode G3, a fourth A electrode G4A and a fourth B electrode G4B obtained by dividing a fourth electrode constituting a focus electrode, an intermediate electrode GM, and a fifth electrode G5 constituting a high-voltage (anode) electrode sequentially arrayed such that each of the electrodes is common to three in-line cathodes K [KR, KG, and KB] corresponding to red, green blue. Further, a shield cup G6 is integrally formed subsequent to the fifth electrode G5. One beam transmitting aperture (not shown in the figure) for each of the cathodes KR, KG, and KB is provided in each of the electrodes from the first electrode G1 to the fifth electrode G5.

A high-voltage potential (anode voltage) of, for example, 20 kV to 35 kV is supplied to the fifth electrode G5. A static focus voltage FS, that is, a requiring voltage fixed within a range of, for example, approximately 5 kV to 10 kV, is supplied to the fourth A electrode G4A constituting the focus electrode. A dynamic focus voltage FV, that is, a requiring voltage variable within a range of, for example, approximately 5 kV to 10 kV, is supplied to the fourth B electrode G4B. A quadrupole lens is formed of the fourth A electrode G4A and the fourth B electrode G4B. To the first electrode G1, zero voltage is supplied. To the second electrode G2, a voltage of approximately 400V to 1500V is supplied. To each of the electrodes G1, G2, G4A, and G4B, a voltage is supplied from a stem pin 31 provided in an electron gun supporting portion. To the fifth electrode G5A, a high-voltage potential is supplied from an anode button through an internal conductive film (such as an internal carbon film) of the cathode-ray tube.

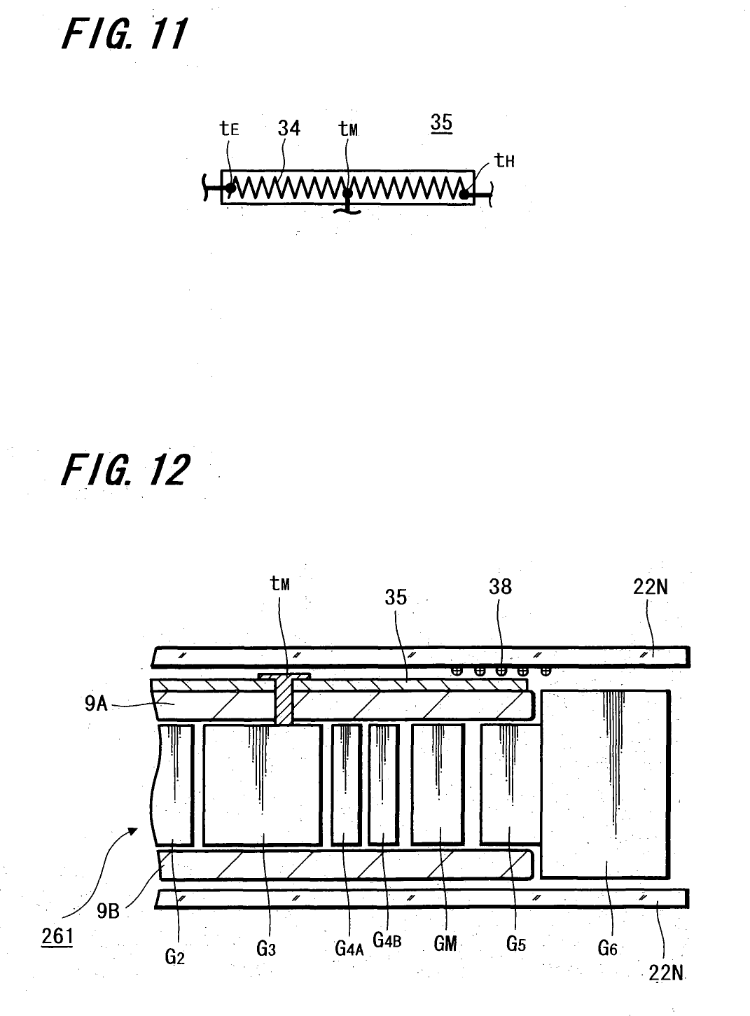

Further, in this embodiment, the third electrode G3 is formed sufficiently longer than the second electrode G2 and the fourth A electrode G4A, and the third electrode G3 and the intermediate electrode GM are conducted. Furthermore, to the third electrode G3 and the intermediate electrode GM, an intermediate voltage VM is supplied in equal potential by means of a voltage divided through an incorporated resistor 35. The supplied intermediate voltage VM is a medium voltage between the anode voltage and the focus voltage FS. Specifically, as shown in FIG. 11, the incorporated resistor 35 is constructed by attaching a resistance 34 to be mounted on one surface of an insulation substrate, coating the surface to be insulated, and then providing an earth terminal tE, a high-voltage terminal tH, and a voltage dividing terminal (medium-voltage terminal) tM on both ends and in the middle of the resistance 34, respectively. The voltage dividing terminal tM is led to the position corresponding to the intermediate voltage VM, for example, led to the position half of the whole length of the resistance 34 when the resistance 34 is formed at equal intervals and the intermediate voltage VM is a half of the anode voltage. In other words, as described later on, the voltage dividing terminal tM is provided at a position where no discharge path on the inside surface of the neck portion occurs. The high-voltage terminal tH of the incorporated resistor 35 is connected to the fifth electrode G5; the earth terminal tE thereof is connected to a stem pin 31 of the earth potential (zero voltage); and the voltage dividing terminal tM thereof is connected to a conductive line of the third electrode G3 and the intermediate electrode GM, thereby supplying the medium potential VM, for example 10 kV to 20 kV, approximately 15 kV in this embodiment, to the third electrode G3 and the intermediate electrode GM.

In the electron gun 261 according to this embodiment, since the medium potential VM, which is equal to that of the intermediate electrode GM, is supplied to the third electrode G3, which is the electrode prior to and next to the fourth electrodes G4A and G4B constituting focus electrodes, and also the third electrode G3 is comparatively long to restrain the repulsion between electron beams emitted from the cathodes K by accelerating the beams at the early stage in the third electrode G3, the increase in diameter of a beam spot on a screen due to repulsion can be restrained. Accordingly, the increase in diameter of the beam spot on a fluorescent screen is restrained to improve the focusing characteristic. The effectiveness of restraining the increase in the beam spot diameter caused by the repulsion is particularly obvious in a high current region.

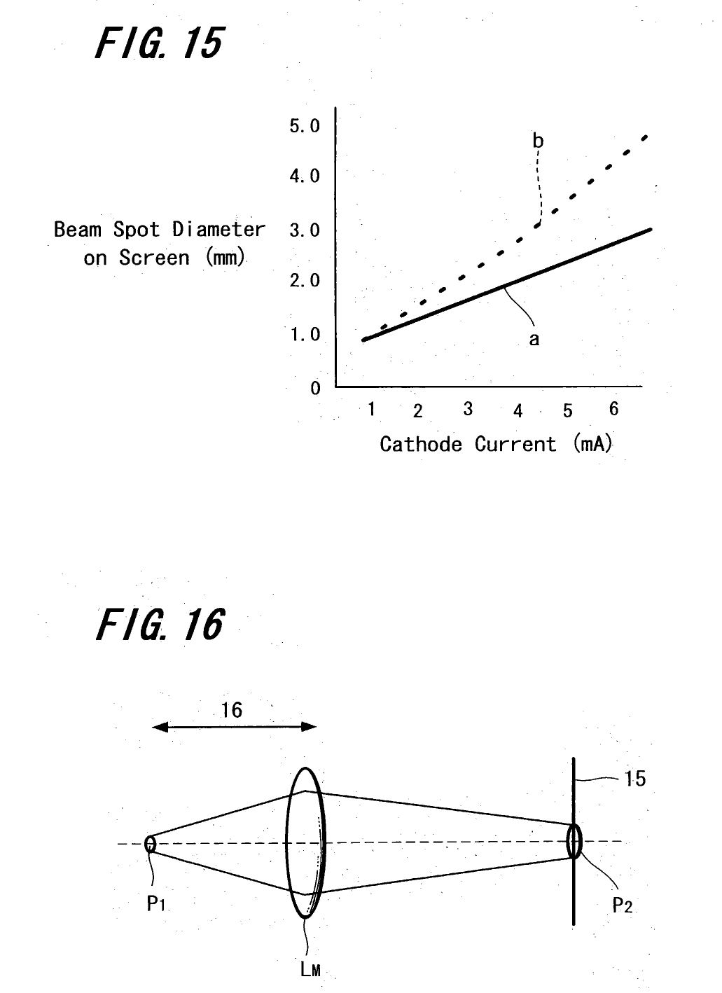

FIG. 15 is a characteristic curve showing the dependency of a beam spot diameter on the cathode current. The curved line (solid line) a shows the characteristic of the electron gun according to the present invention, and the curved line (broken line) b shows the characteristic of a conventional electron gun. Compared to the increase in the beam spot diameter in the conventional electron gun, in the electron gun according to the present invention the increase is restrained in the range of a low current region to a high current region, which is particularly obvious in the high current region.

Further, in this embodiment a voltage withstanding characteristic can be improved. Specifically, while the intermediate voltage VM is supplied to the third electrode G3 and the intermediate electrode GM by means of a voltage divided from the incorporated resistor 35, the medium voltage terminal tM can be positioned distant from the high-voltage terminal tH in the incorporated resistor 35 to restrain the discharge between the medium voltage terminal tM and the high-voltage charged portion 38 of the inside surface of the neck, thereby improving the voltage withstanding characteristic. In this embodiment, the potential of the medium voltage terminal tM is approximately half of the high voltage (anode voltage), and the position of the medium voltage terminal tM can be set at about the center of the whole length of the resistance 34, so that a resistance pattern can be designed without difficulty.

According to the color cathode-ray tube 1 provided with the electron gun 261 of the present invention, the focusing characteristic and the voltage withstanding characteristic are both improved, and a highly-reliable color cathode-ray tube in high intensity and high resolution can be obtained.

FIG. 10 shows another embodiment of the electron gun 26 according to the above-described present invention. An in-line type electron gun 262 according to the embodiment includes a plurality of electrodes: a first electrode G1, a second electrode G2, a third electrode G3, a fourth electrode G4, a fifth A electrode G5A and a fifth B electrode G5B obtained by dividing a fifth electrode constituting a focus electrode, an intermediate electrode GM, and a sixth electrode G6 constituting a high-voltage (anode) electrode sequentially arrayed such that each of the electrodes is common to three in-line cathodes K [KR, KG, and KB] corresponding to red, green blue. Further a shield cup G7 is integrally formed subsequent to the sixth electrode G6. One beam transmitting aperture (not shown in the figure) for each of the cathodes KR, KG, and KB is provided in each of the electrodes from the first electrode G1 to the sixth electrode G6.

A high-voltage potential (anode voltage) of, for example, 20 kV to 35 kV is supplied to the sixth electrode G6. A static focus voltage FS, that is, a requiring voltage fixed within a range of, for example, approximately 5 kV to 10 kV, is supplied to the fifth A electrode G5A, that is, a focus electrode and the third electrode G3, and a dynamic focus voltage FV, that is, a requiring voltage variable within a range of, for example, approximately 5 kV to 10 kV, is supplied to the fifth B electrode G5B. A quadrupole lens is formed of the fifth A electrode G5A and the fifth B electrode G5B. To the first electrode G1, zero voltage is supplied. To the second electrode G2, a voltage of approximately 400V to 1500V is supplied. To each of the electrodes G1, G2, G3, G5A, and G5B, a voltage is supplied from a stem pin 31 provided in an electron gun supporting portion. To the sixth electrode G6, a high-voltage potential is supplied from an anode button through an internal conductive film (such as an internal carbon film) of the cathode-ray tube.

Further, in the electron gun 262 according to this embodiment, the fourth electrode G4 is formed longer than the third electrode G3 and the fifth A electrode G5A, and the fourth electrode G4 and the intermediate electrode GM are conducted, where an intermediate voltage VM is supplied in equal potential to both the electrodes by means of a voltage divided through an incorporated resistor 35. The construction and disposition of the incorporated resistor 35, the position of the voltage dividing terminal (medium voltage terminal) tM, and the like are similar to those in the embodiment described above.

According to the electron gun 262 of this embodiment, since the medium potential VM which is equal to that of the intermediate electrode GM is supplied to the fourth electrode G4, which is the electrode prior to and next to the fifth electrodes G5A and G5B constituting focus electrodes, and also the fourth electrode G4 is comparatively long to restrain the repulsion between electron beams emitted from the cathodes K by accelerating the beams at the early stage in the fourth electrode G4, the increase in diameter of a beam spot on a screen due to the repulsion can be restrained. Accordingly, the focusing characteristic can be improved in the range of a low current region to a high current region. Also, since the voltage dividing terminal tM is provided distant from the high-voltage charged portion 38 of the inside surface of the neck, discharge between the voltage dividing terminal tM and the high-voltage charged portion 38 is restrained to improve a voltage withstanding characteristic.

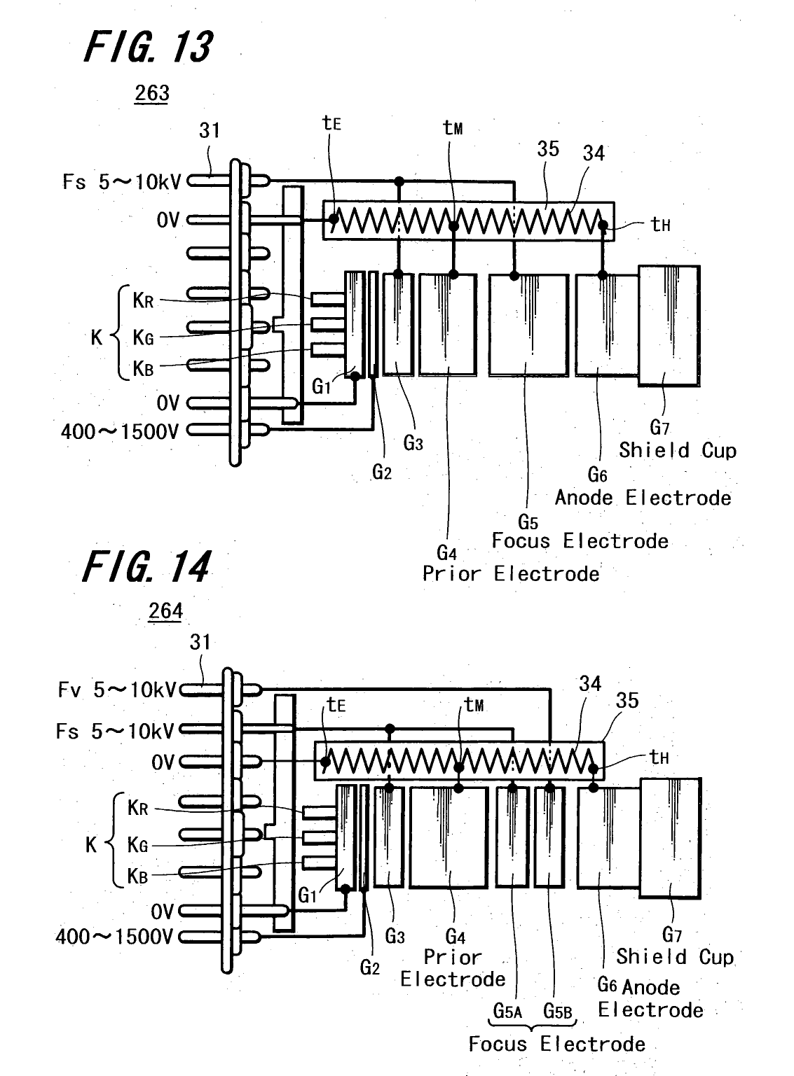

FIGS. 13 and 14 show further embodiments of the electron gun 26 according to the above-described present invention, in which an intermediate electrode GM is not provided.

An in-line-type electron gun 263 according to the embodiment shown in FIG. 13 includes a plurality of electrodes: a first electrode G1, a second electrode G2, a third electrode G3, a fourth electrode G4, a fifth electrode G5 constituting a focus electrode, a sixth electrode G6 constituting an anode electrode, and a shield cup G7 sequentially arrayed such that each of the electrodes is common to three in-line cathodes K [KR, KG, and KB]. A high-voltage potential VH of, for example, approximately 20 kV to 35 kV is supplied to the sixth electrode G6. A static focus voltage FS of, for example, approximately 5 kV to 10 kV is supplied to the fifth electrode G5 and the third electrode G3. To the second electrode G2 a low voltage of approximately 400V to 1500V is supplied, and to the first electrode G1 zero voltage is supplied. Through a stem pin 31, a voltage is supplied to each of the electrodes G1, G2, G3, and G5. The fifth electrode G5 and the sixth electrode G6 constitute a main electron lens.

Further, in this embodiment an intermediate potential VM between the high-voltage potential VH and the focus potential FS is supplied to the fourth electrode G4 by means of a voltage divided through the incorporated resistor 35. The construction and disposition of the incorporated resistor 35, the position of the voltage dividing terminal (medium voltage terminal) tM, and the like are similar to those in the embodiments described above.

An in-line type electron gun 264 according to the embodiment shown in FIG. 14 includes a plurality of electrodes: a first electrode G1, a second electrode G2, a third electrode G3, a fourth electrode G4, a fifth A electrode G5A and a fifth B electrode G5B constituting a focus electrode, a sixth electrode G6, and a shield cup G7 sequentially arrayed such that each of the electrodes is common to three in-line cathodes K [KR, KG, and KB]. A high-voltage potential VH of, for example, approximately 20 kV to 35 kV is supplied to the sixth electrode G6. To both the fifth A electrode G5A and the third electrode G3, which are conducted, a static focus voltage FS, that is, a requiring voltage fixed within a range of, for example, approximately 5 kV to 10 kV, is supplied, and a dynamic focus voltage FV, that is, a requiring voltage variable within a range of, for example, approximately 5 kV to 10 kV, is supplied to the fifth B electrode G5B. A quadrupole lens is formed of the fifth A electrode G5A and the fifth B electrode G5B. To the second electrode G2, a low voltage of approximately 400V to 1500V is supplied, and to the first electrode G1, zero voltage is supplied. To each of the electrodes G1, G2, G3, G5A, and G5B, a voltage is supplied from a stem pin 31.

Further, in this embodiment, an intermediate potential VM between the high-voltage potential VH and the focus potential FS is supplied to the fourth electrode G4, which is the prior electrode to the focus electrodes G5A and G5B, by means of a voltage divided through an incorporated resistor 35. The construction and disposition of the incorporated resistor 35, the position of the voltage dividing terminal (medium voltage terminal) tM, and the like are similar to those in the embodiments described above.

According to each of the electron guns 263 and 264 of the above-described embodiments, a focusing characteristic, a voltage withstanding characteristic, and the like can be improved in the range of a low current region to a high current region, and a similar effectiveness to the above-described embodiments is obtained.

Further, although a medium voltage VM may be supplied independently from a stem pin 31 to the third electrode G3 or the fourth electrode G4, it is advantageous to supply the voltage through the incorporated resistor 35, in light of the withstanding voltage between the stem pins on the stem pin side.

Although, in the above embodiments, one beam transmitting aperture for each of the cathodes KR, KG, and KB is provided on each of the electrodes G1 to G5, the present invention can also be applied to other electron guns, such as a multi-beam electron gun, in which a plurality of, for example two, beam transmitting apertures for each of the cathodes KR, KG, and KB are provided at least on the first and second electrodes G1 and G2.

In the above embodiments, the present invention is applied to an in-linetype electron gun. However, the present invention can also be applied to an electron gun of a single-color cathode ray tube used in a projection-type display apparatus (projector).

According to the electron gun of the present invention, the focusing characteristic can be improved when compared to that of a conventional one. Specifically, the diameter of a beam spot irradiated on the fluorescent screen can be made small, particularly in a high cathode-current region.

According to the electron gun of the present invention, when a medium voltage VM is supplied to a requiring electrode through an incorporated resistor, the discharge between the voltage dividing terminal of the incorporated resistor and the high-voltage charged portion of the inside surface of the neck is prevented, thereby improving the voltage withstanding characteristic. Further, since the voltage dividing terminal can be positioned on a lower voltage side, the resistance pattern of the incorporated resistor can be designed without difficulty.

According to the cathode-ray tube of the present invention, since the cathode-ray tube includes the above-described electron gun, the focusing characteristic can be improved in the range of a low cathode current region to a high cathode current region, and the voltage withstanding characteristic can be improved, thereby further enabling a picture in high resolution and high reliability to be obtained.

Having described preferred embodiments of the invention with reference to the accompanying drawings, it is to be understood that the invention is not limited to those precise embodiments and various changes and modifications could be effected therein by one skilled in the art without departing from the spirit or scope of the invention as defined in the appended claims.

What is claimed is:

What is claimed is:

1. An electron gun comprising:
a focus electrode,
an anode electrode disposed on a side subsequent to said focus electrode, and
a prior electrode disposed on a side prior to and next to said focus electrode, wherein
an intermediate potential between an anode potential and a focus potential is supplied to said prior electrode by means of a voltage divided through a resistor.

2. An electron gun comprising:
a focus electrode,
an anode electrode disposed on a side subsequent to said focus electrode,
an intermediate electrode disposed between said focus electrode and said anode electrode, and
a prior electrode disposed on a side prior to and next to said focus electrode, wherein
an intermediate potential between an anode potential and a focus potential is supplied in equal potential to said prior electrode and said intermediate electrode by means of a voltage divided through a resistor.

3. An electron gun according to claim 1, wherein
said focus electrode constitutes a quadrupole lens, comprising an electrode to which a dynamic focus voltage is applied and an electrode to which a static focus voltage is applied.

4. An electron gun according to claim 2, wherein
said focus electrode constitutes a quadrupole lens, comprising an electrode to which a dynamic focus voltage is applied and an electrode to which a static focus voltage is applied.

5. An electron gun according to claim 1, wherein
a voltage dividing terminal of said resistor is provided at a position corresponding to said intermediate potential.

6. An electron gun according to claim 2, wherein
a voltage dividing terminal of said resistor is provided at a position corresponding to said intermediate potential.

7. A cathode-ray tube comprising:
an electron gun including a focus electrode,
an anode electrode disposed on a side subsequent to said focus electrode, and
a prior electrode, disposed on a side prior to and next to said focus electrode, wherein
an intermediate potential between an anode potential and a focus potential is supplied to said prior electrode by means of a voltage divided through a resistor.

8. A cathode-ray tube comprising:
an electron gun including a focus electrode,
an anode electrode disposed on a side subsequent to said focus electrode,
an intermediate electrode disposed between said focus electrode and said anode electrode, and
a prior electrode disposed on a side prior to and next to said focus electrode, wherein
an intermediate potential between an anode potential and a focus potential is supplied in equal potential to said prior electrode and said intermediate electrode by means of a voltage divided through a resistor.

9. A cathode-ray tube according to claim 7, wherein
said focus electrode of said electron gun constitutes a quadrupole lens, comprising an electrode to which a dynamic focus voltage is applied and an electrode to which a static focus voltage is applied.

10. A cathode-ray tube according to claim 8, wherein
said focus electrode of said electron gun constitutes a quadrupole lens, comprising an electrode to which a dynamic focus voltage is applied and an electrode to which a static focus voltage is applied.

11. A cathode-ray tube according to claim 7, wherein
a voltage dividing terminal of said resistor is provided at a position corresponding to said intermediate potential.

12. A cathode-ray tube according to claim 8, wherein
a voltage dividing terminal of said resistor is provided at a position corresponding to said intermediate potential.
